(19) United States
(12) Patent Application Publication
(10) Pub. No.: US 2020/0266498 A1
(43) Pub. Date: Aug. 20, 2020

(54) LEAD-ACID BATTERY RESTORATION AGENTS CONTAINING GRAPHENE MATERIALS

(71) Applicant: Chaoxian Xiao, Ames, IA (US)

(72) Inventor: Chaoxian Xiao, Ames, IA (US)

(73) Assignee: Neweem Ltd. Co., Ames, IA (US)

(21) Appl. No.: 16/278,730

(22) Filed: Feb. 19, 2019

(51) Int. Cl. H01M 10/42; H01M 10/08; C01B 32/194; C01B 32/198

(52) U.S. Cl. CPC H01M 10/4242; H01M 10/08; C01B 32/194; C01B 2204/22; H01M 2300/0005; C01B 2204/02; C01B 2204/04; C01B 32/198

(57) ABSTRACT

The present invention relates to an agent for the restoration of lead-acid batteries. The agent includes graphene materials and appropriate non-ionic dispersion agents. This agent is stable when used in the electrolytes of lead-acid batteries. The process of producing the restoration agent involves making graphene materials, and mixing graphene material with dispersing agents in water. Also disclosed is its use in a process for the restoration of lead-acid batteries.

### FIELD OF THE INVENTION

The present invention relates to an agent containing graphene materials which can be used for the maintenance of lead-acid batteries.

### BACKGROUND OF THE INVENTION

Lead-acid batteries have been used extensively as energy storage devices in automotive, electric cars, and uninterruptible power supply, etc. Lead acid batteries consist of positive and negative plates made of lead compounds and electrolytes.

During discharge, metallic lead (Pb) on negative plate and lead dioxide (PbO₂) on positive plate were converted to lead sulfate (PbSO₄) in the presence of sulfuric acid electrolyte (Lead-acid battery technologies: Fundamentals, Materials, and Applications, by Joey Jung, Lei Zhang, and Jiujun Zhang (Editors), Chapter 1, pp. 10-12):

Pb+H₂SO₄→PbSO₄+2H⁺+2e Negative:

PbO₂+H₂SO₄+2H⁺+2e→PbSO₄+2H₂O Positive:

During charge, lead sulfate (PbSO₄) was converted to amorphous metallic lead (negative plate) or lead dioxide (positive plate):

PbSO₄+2H⁺+2e→Pb+H₂SO₄ Negative:

PbSO₄+2H₂O→PbO₂+H₂SO₄+2H⁺+2e Positive:

When discharge is followed immediately by charging the battery, the conversion of lead sulfate to lead or lead dioxide is feasible. However, if the batteries were stored at discharge status for a long time, big lead sulfate crystal may appear due to self-discharge. Such big lead sulfate crystals have very poor electrical conductivity. Therefore, it is very difficult to convert them back to active lead or lead dioxide during the electrochemical process. The formation of inactive lead sulfate crystals (so-called sulfation process) is one of the major reasons of capacity loss of lead-acid batteries. Sulfated batteries need to be replaced if their capacity dropped too much to support the desired workload. Misuse and improper maintenance of lead-acid batteries, such as lack of sufficient electrolyte fluid, overcharging or discharging, may deteriorate the situation and further shorten battery life.

Battery manufacturers already took some efforts to mitigate sulfation problem and improve the batteries' life. For instance, some fillers such as conductive carbon black and graphite were added to the plates to enhance the conductivity of lead compounds in the plates. Other ingredients including some binders and surfactants (e.g., barium sulfate, lignosulfonates) were used to make better dispersion of lead compounds and restrict the particle sizes of lead sulfate. However, these strategies could not prevent battery sulfation completely.

Several methods have been developed to dissolve or activate lead sulfate crystals to restore battery capacity. For instance, U.S. Pat. No. 5,945,236, by Willis, claims that a mixture of metal salts including aluminium sulfate, cobalt sulfate, copper sulfate, magnesium sulfate, cadmium sulfate, sodium sulfate, and potassium sulfate, would remove inactive lead sulfate crystals of lead-acid batteries to improve battery performance characteristics. However, the addition of such salts may cause erosion of the plate grid of the batteries, leading to ultimate battery failure.

U.S. Pat. No. 5,648,714 claims that a device with pulse charging may convert sulfated lead compounds to active lead. However, the use of electrical pulse may have a severe impact on the plates and even get rid of lead compounds from the plates, thus cause permanent capacity loss.

Therefore, a need exists for a new type of agent for the restoration of lead-acid batteries. Graphene, a new kind of carbon material comprising a monolayer or multiple layer carbon atoms packed in a hexagonal honeycomb lattice, has appealing properties such as extremely high electrical conductivity, excellent thermal conductivity and high surface area. It has been found that including graphene in the formation of lead-acid battery plates can improve the stability and extend the life (U.S. Patent Publication No. 20180151872). However, it is difficult to make uniform and stable dispersion of graphene in electrolytes, because graphene aggregates in aqueous solution due to its hydrophobic nature. Further methods must be developed to achieve uniform and stable dispersion of graphene in electrolytes.

### SUMMARY OF THE INVENTION

The present invention provides an agent for the restoration of lead-acid batteries which have lower capacity compared to their original condition. The agent comprises graphene, dispersion agents and reducing agents. An advantage of this agent is that it includes uniform dispersion of graphene in the solution, particularly in the electrolytes, which is essential for electrically conductive graphene to interact with the plates and activate “inactive” lead sulfate compounds.

The present invention also relates to a process to make an agent to improve the capacity of lead-acid batteries. The process includes pre-treating graphite in sulfuric acid, oxidizing graphite, separating graphitic oxide, making graphene oxide, reducing graphene oxide, and dispersing reduced graphene oxide.

In another embodiment, some electrically conductive agents such as carbon nanotubes, carbon fibers, carbon black, and conductive polymers could be also added to this agent to achieve the desired performance, which shall be also included in this invention.

### BRIEF DESCRIPTION OF THE DRAWINGS

FIG. 1 is a graph showing adding the graphene-containing agent to a lead-acid battery, charging and/or discharging the battery to restore the capacity of lead-acid batteries.

### DETAILED DESCRIPTION OF THE INVENTION

The present invention relates to an agent for the restoration of lead acid batteries. As mentioned in the Background section, sulfation is one of the main reasons which are responsible for the ultimate failure of lead acid batteries. The sulfated compound, lead sulfate, has very poor electrical conductivity which is difficult to convert to active lead or lead oxide, leading to capacity loss.

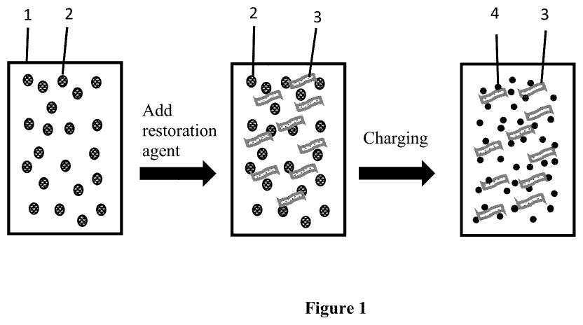

As illustrated in FIG. 1, graphene 3 contained in this restoration agent may adhere to the surface of sulfated lead plates 1. Owing to the excellent electrical conductivity of graphene materials, the interaction between graphene 1 and lead sulfate 2 may improve the electrical conductivity of sulfated lead plates 1 and facilitate the conversion of lead sulfate crystals 2 to lead or lead dioxide 4 during electrochemical process. In addition, graphene 3 has very high surface area (typically >300 m²/g), which is beneficial to stabilize the lead compounds including lead sulfate, lead and lead dioxide, and prevent the formation of big lead sulfate crystals 2. In such a way, the sulfation problem could be minimized. And the battery life could be extended.

Graphene could be produced by various means. In one embodiment, graphene was obtained by the reduction of graphene oxide in aqueous solution with appropriate reducing agents including but not limited to hydrazine, zinc powder, hydrogen, tin dichloride, hypophosphorous acid, sodium hypophosphite, oxalic acid, formic acid, ascorbic acid, formaldehyde, and reducing sugar such as glucose. The graphene product after reduction is also called as reduced graphene oxide.

In another embodiment, graphene was obtained by thermal treatment of graphene oxide under hydrogen or inert atmosphere at 300-1000° C. Graphene oxide was exfoliated and decomposed in this process to produce reduced graphene oxide.

In another embodiment, graphene was obtained by electrochemical treatment of graphite cathode or anode using appropriate electrolyte, electric current and voltage (see: K. Parvez et al, Exfoliation of Graphite into Graphene in Aqueous Solutions of Inorganic Salts, J. Am. Chem. Soc., 2014, 136, 6083-6091).

Graphene oxide can be obtained from multiple sources. In one embodiment, Graphene oxide was obtained by the exfoliation of graphitic oxide which can be made by Hummers' method (see: William S. Hummers, Richard E. Offeman, Preparation of Graphitic Oxide, J. Am. Chem. Soc., 1958, 80(6): 1339). Concentrated sulfuric acid was mixed with graphite powder. Then the oxidants were added to the mixture. Appropriate oxidants include but are not limited to potassium permanganate, nitric acid, sodium nitrate, potassium chlorate, potassium chromate, and hydrogen peroxide. Graphitic oxide was obtained after the oxidation process. Graphitic oxide was separated from the mixture with various methods including but not limited to centrifugation, filtration, freeze drying, precipitation, and dialysis. Various exfoliation methods such as sonication, centrifugation, thermal treatment, microwave treatment could be used to separate the graphitic layers of graphitic oxide to make graphene oxide or graphene.

In another embodiment, graphite was added to the mixture of concentrated sulfuric acid and sodium nitrate. Then the oxidants were added to the mixture. The oxidants include but are not limited to potassium permanganate, nitric acid, sodium nitrate, potassium chlorate, potassium chromate, and hydrogen peroxide. Graphitic oxide was obtained after the oxidation process. Graphitic oxide was separated from the mixture with various methods including but not limited to centrifugation, filtration, freeze drying, precipitation, and dialysis. Various exfoliation methods such as sonication, centrifugation, thermal treatment, microwave treatment could be used to prepare graphene oxide or graphene from graphitic oxide.

In another embodiment, graphite was added to the mixture of concentrated phosphoric acid. Then the oxidants were added to the mixture. The oxidants include but are not limited to potassium permanganate, nitric acid, sodium nitrate, potassium chlorate, potassium chromate, and hydrogen peroxide. Graphitic oxide was obtained after the oxidation process. Graphitic oxide was separated from the mixture with various methods including but not limited to centrifugation, filtration, freeze drying, precipitation, and dialysis. Various exfoliation methods such as sonication, centrifugation, mechanical agitation, thermal treatment, and microwave radiation, could be used to prepare graphene oxide or graphene from graphitic oxide.

Because graphene is a hydrophobic material, it may aggregate in aqueous solution. Appropriate dispersion agents are required to make a uniform and stable solution containing graphene. Such dispersion agents include but are not limited to non-ionic surfactants such as polyvinyl alcohol (PVA), polyethylene glycol (PEG), polyvinylpyrrolidone (PVP), polyacrylic acid, polymer pluronic P123, Triton X-100, and ionic surfactants such as cetyl trimethyl ammonium bromide (CTAB), sodium dodecyl sulfate (SDS), sodium benzyl sulfate, 4-(5-dodecyl) benzenesulfonate, ammonium lauryl sulfate, and sodium lignosulfonate. Uniform graphene dispersion could be obtained by mixing graphene with the appropriate amount of dispersion agents in water.

However, when the graphene dispersion was added to the electrolytes of lead-acid batteries, typically 30-40% sulfuric acid aqueous solution, some dispersion agents failed to stabilize graphene. This invention disclosed that graphene aggregates in such a high concentration of sulfuric acid when using ionic dispersion agents such as CTAB and SDS. Non-ionic dispersion agents showed good stability in presence of sulfuric acid. The concentration of dispersion agents is 0.01-50% by weight.

Other materials with good electrical conductivity could be also added to the battery restoration agent to enhance the performance. These materials include but are not limited to carbon nanotubes, carbon fibers, carbon black and conductive polymers such as polyaniline, polyacetylene and polythiophene.

In one embodiment, the mixture comprising graphene and dispersion agents is used as the battery restoration agent directly. The concentration of graphene is 0.01-1% by weight.

In another embodiment, one or more reducing agents are added to the graphene dispersion solution to promote the dispersion of graphene and enhance the performance. The reducing agents include but are not limited to sodium borohydride, potassium borohydride, ammonium borohydride, zinc powder, magnesium powder, aluminum powder, methanol, ethanol, propanol, isopropanol, 1,2-propanediol, 1,3-propanediol, ethylene glycol, diethylene glycol, triethylene glycol, tetraethylene glycol, polyethylene glycol, formic acid, oxalic acid, ascorbic acid, formaldehyde, hydrogen iodide, hydrazine, amino acid, protein, starch, glucose, sucrose, tin dichloride, hypophosphorous acid, and sodium hypophosphite. The concentration of the reducing agent is 0.01-50% by weight.

In another embodiment, inorganic additives may be added to the graphene solution to promote the dispersion of graphene and enhance the performance. Such metal salts include but are not limited to phosphoric acid, lithium sulfate, sodium sulfate, magnesium sulfate, potassium sulfate, stannic chloride, stannic chloride dihydrate, silica, zinc oxide, magnesium oxide, manganese dioxide, magnesium sulfate, copper sulfate, aluminium sulfate, and bismuth nitrate. The concentration of inorganic additives is 0.01-90% by weight.

In one embodiment, the battery restoration agent is an aqueous solution. In another embodiment, the agent may be evaporated to produce a solid or powder containing graphene, which can be added to the electrolyte for the restoration of lead-acid batteries.

As used herein, the term “graphene” is intended to mean pristine graphene, reduced graphene oxide, graphene fluoride, hydrogenated graphene, nitrogenated graphene, doped graphene, or chemically functionalized graphene. Preferably, graphene comprises single-layer graphene or few-layer graphene, wherein said few-layer graphene refers to a graphene platelet with 2-10 graphene planes. Some impurity atoms such as oxygen and hydrogen may be present in graphene materials. The lateral size of graphene may range from 0.001-1000 micrometer. The graphene layers may be wrinkled or flat.

As used herein, the term “graphene oxide” refers to oxidized graphene including but not limited to functional groups such as hydroxyl, carboxyl, and peroxyl group.

As used herein, the term “exfoliation” refers to the process of separate the layers of graphite or graphite oxide to get individual layers of graphene or graphene oxide. Exfoliation methods include but not limited to centrifugation, mechanical agitation, heating, microwave radiation, ultrasonication, chemical oxidation, and electrochemical treatment.

### EXAMPLES

### Example 1—Stability of Graphene in Electrolytes with Various Dispersion Agents

The stability of graphene in electrolytes (typically 30-40% sulfuric acid) was tested using various dispersion agents. Graphene (10 mg, made by electrochemical exfoliation of graphite) and the dispersion agents (100 mg) were mixed with water (10 mL) under sonication. Non-ionic surfactants such as polyvinyl alcohol (PVA), polyvinylpyrrolidone (PVP), and polymer pluronic P123, and ionic surfactants such as cetyl trimethyl ammonium bromide (CTAB), sodium dodecyl sulfate (SDS) are used as the dispersion agents are tested. Uniform graphene dispersion can be obtained by using any one of the above dispersion agents in water. Then 1 mL of the above dispersion was mixed with 10 mL of electrolytes (35% sulfuric acid aqueous solution). As shown in Table 1, organic polymer surfactants such as PVA, PVP, and Pluronic P123 showed good stability for dispersing the graphene in the electrolytes. However, ionic surfactants such as SDS and CTAB cannot stabilize the graphene in electrolytes.

TABLE 1
Stability of graphene in electrolytes with various dispersion agents

| | Dispersion Agent | | | | |
|---|---|---|---|---|---|
| | PVA | PVP | Pluronic P123 | SDS | CTAB |
| Results | Stable | Stable | Stable | Aggregate | Aggregate |

### Example 2—Battery Restoration Agent A

Graphene (20 g) and polyvinylpyrrolidone (PVP; 20 g) were mixed with deionized water (20 L), followed by vigorous sonication for one hour. A uniform solution containing graphene was obtained, which was used as battery restoration agent A.

### Example 3—Battery Restoration Agent B

Graphene (20 g) and polyvinyl alcohol (PVA; 400 g) were mixed with deionized water (20 L), followed by vigorous sonication for one hour. A uniform solution containing graphene was obtained, which was used as battery restoration agent B.

### Example 4—Battery Restoration Agent C

Graphene (2 g) and polyvinyl alcohol (PVA; 4 g) and ascorbic acid (20 g) were mixed with deionized water (20 L), followed by vigorous sonication for one hour. A uniform solution containing graphene was obtained, which was used as battery restoration agent C.

### Example 5—Battery Restoration Agent D

Graphene (40 g), polyvinylpyrrolidone (PVP; 600 g) and ethylene glycol (500 mL) were mixed with deionized water (20 L), followed by vigorous sonication for one hour. A uniform solution containing graphene was obtained, which was used as battery restoration agent D.

### Example 6—Restore Lead-Acid Battery No. 1

One pair of positive and negative plates of a SLI car battery was artificially deactivated (sulfated) by charging and discharging at large current. The capacity was measured with a battery tester by discharging the battery to 1.75 V (per unit). The original capacity of the plates was 2.78 AH. The final capacity after deactivation dropped to 1.91 AH, about 60% of the original capacity. Then graphene solution (battery restoration agent A, 1.4 mL) containing 14 mg of graphene was added to the electrolyte. The battery was charged at 0.4 A at 2.67V until the current reaches 0.05 A. Then it was discharged at 2 A until 1.75V. The capacity increased to 3.6 AH after the restoration, which is 30% higher than the original capacity.

### Example 7—Restore Lead-Acid Battery No. 2

The positive and negative plates of a SLI car battery were cut into small pieces, which were used for the test. These small plates were artificially deactivated by charging and discharging at large current for multiple cycles. The original capacity is 0.539 AH. And the final capacity dropped to 0.383 AH, about 70% of the original capacity. Graphene solution (battery restoration agent B, 0.7 mL) containing 14 mg of graphene was added to the electrolytes. The electrodes were charged at 1.4 A at 2.67 V until the current reaches 0.05 A. Then they are discharged at 1 A until 1.75 V. The capacity reaches 0.47 AH after the first charging/discharging (87%), and 0.50 AH after the second charging/discharging (93%). The capacity was fully recovered.

### Example 8—Restore Lead-Acid Battery No. 3

A used SLI car battery (manufactured by Interstate Batteries) was tested with battery restoration agent C. The battery can reach only 10.9 V after fully charged before the test. Its original capacity was 55.9 AH. After adding graphene restoration (battery restoration agent C, 66 mL), the battery was charged at 5 A, 17 V for 24 hours. The capacity was improved to 72.4 AH (130% of original capacity). The battery was successfully restored.

### Example 9—Restore Lead-Acid Battery No. 4

Battery restoration agent D was applied to forklift batteries (Specification: 48V, 560 AH). These batteries have been regularly used in the practical environment for at least three years. The capacity dropped to 272.9 AH before the restoration. After the addition of battery restoration agents D (13 mL per unit per 100 AH), the batteries were charged for 24 hours and then discharged. The capacity was improved significantly to 464.5 AH (82.8% of the original capacity).

What is claimed is:

1. An agent for the restoration of lead-acid batteries comprising graphene materials and dispersion agents.

2. The agent of claim 1, wherein graphene materials are selected from reduced graphene oxide, mono-layer graphene, and few-layer graphene (2-10 layers).

3. The agent of claim 1, wherein graphene materials are produced through oxidation, reduction, physical exfoliation, electrochemical exfoliation, or chemical synthesis.

4. The agent of claim 1, wherein the graphene material is reduced graphene oxide.

5. The agent of claim 1, wherein the concentration of graphene materials is 0.01%-1% by weight.

6. The agent of claim 1, wherein one or more dispersion agents are selected from polyvinyl alcohol (PVA), polyethylene glycol (PEG), polyvinylpyrrolidone (PVP), polyacrylic acid, polymer Pluronic P123, and Triton X-100.

7. The agent of claim 1, wherein the concentration of the dispersion agent is 0.01-10% by weight.

8. The agent of claim 1, wherein the dispersion agent is polyvinyl alcohol.

9. The agent of claim 1, wherein the dispersion agent is polyvinylpyrrolidone.

10. The agent of claim 1, wherein the dispersion agent is polymer Pluronic P123.

11. An agent for the restoration of lead-acid batteries comprising graphene materials, dispersion agents and reducing agents.

12. The agent of claim 11, wherein graphene materials are selected from reduced graphene oxide, mono-layer graphene, and few-layer graphene (2-10 layers).

13. The agent of claim 11, wherein graphene materials are produced through oxidation, reduction, physical exfoliation, electrochemical exfoliation, or chemical synthesis.

14. The agent of claim 11, wherein the graphene material is reduced graphene oxide.

15. The agent of claim 11, wherein the concentration of graphene materials is 0.01%-1% by weight.

16. The agent of claim 11, wherein dispersion agents are selected from polyvinyl alcohol (PVA), polyethylene glycol (PEG), polyvinylpyrrolidone (PVP), polyacrylic acid, polymer pluronic P123, and Triton X-100.

17. The agent of claim 11, wherein the concentration of the dispersion agent is 0.05-10% by weight.

18. The agent of claim 11, wherein the dispersion agent is polyvinyl alcohol.

19. The agent of claim 11, wherein the dispersion agent is polyvinylpyrrolidone.

20. The agent of claim 11, wherein the dispersion agent is polymer pluronic P123.

21. The agent of claim 11, wherein the reducing agent is selected sodium borohydride, potassium borohydride, ammonium borohydride, zinc, magnesium, aluminum, methanol, ethanol, propanol, isopropanol, 1,2-propanediol, 1,3-propanediol, ethylene glycol, diethylene glycol, triethylene glycol, tetraethylene glycol, polyethylene glycol, formic acid, oxalic acid, ascorbic acid, formaldehyde, hydrogen iodide, hydrazine, amino acid, protein, starch, glucose, sucrose, tin dichloride, hypophosphorous acid, and sodium hypophosphite.

22. The agent of claim 11, wherein the concentration of the reducing agent is 0.01-50% by weight.
